(19) United States
(12) Patent Application Publication
(10) Pub. No.: US 2011/0022416 A1
(43) Pub. Date: Jan. 27, 2011

(54) SYSTEM AND METHOD TO PROVIDE INSURANCE QUOTE

(76) Inventors: Keith Eric Bergquist, Colchester, CT (US); Jonathan Kaleb Adams, Middletown, CT (US)

Correspondence Address: BUCKLEY, MASCHOFF & TALWALKAR LLC, 50 LOCUST AVENUE, NEW CANAAN, CT, 06840, US

(21) Appl. No.: 12/507,969

(22) Filed: Jul. 23, 2009

(51) Int. Cl. G06Q 40/00

(52) U.S. Cl. 705/4

(57) ABSTRACT

A method includes a data storage device for receiving, storing, and providing access to building characteristic information, a computer processor for executing program instructions and for retrieving the building characteristic information and hazard information from the data storage device, a memory, coupled to the computer processor, for storing program instructions for execution by the computer processor, a quoting system and a validation engine.

The quoting system includes program instructions stored in the memory for presenting a first interface to a user to receive location data, retrieving building characteristic information from a first one or more third-party systems based on the location data, presenting a second interface to the user pre-populated with the building characteristic information, generating a quote for a homeowner's insurance policy based on the building characteristic information, receiving a request to purchase the homeowner's insurance policy, receiving payment corresponding to the quote, and issuing the homeowner's insurance policy when executed by the computer processor.

The validation engine includes program instructions stored in the memory, for determining key data elements associated with the quote and validating values of the key data elements, when executed by the computer processor. A communication device, coupled to the computer processor, presents the first interface and the second interface.

### FIELD

Embodiments relate to systems and methods to facilitate data acquisition and validation related to insurance quoting.

### BACKGROUND

A homeowner's insurance quote is generated based on information relating to the home to be insured. The information may be used to determine if the risk to the home is insurable and then to determine a price for insuring against that risk. This information may include home location, home size and home quality. Typically, a homeowner provides this information to an agent, who navigates several computing systems to generate a price quote based on the information.

Aggregating and providing this information is particularly burdensome to the homeowner, and the prospect thereof may discourage the homeowner from requesting a quote. Entry of the information into the appropriate computing systems can also be unacceptably time-consuming. Moreover, the suitability of the generated quote is dependent upon the accuracy of the information provided by the homeowner and the experience of the agent.

Systems and methods are desired to facilitate insurance quoting. Such systems may be particularly useful for insurances, such as homeowner's insurance, which depend upon a significant breadth of information relating to the entity to be insured.

### SUMMARY

Some embodiments provide efficient acquisition and validation of information usable to generate an insurance quote.

A computer system is described which includes a data storage device for receiving, storing, and providing access to building characteristic information, a computer processor for executing program instructions and for retrieving the building characteristic information from the data storage device, a memory, coupled to the computer processor, for storing program instructions for execution by the computer processor, a quoting system and a validation engine.

The quoting system includes program instructions stored in the memory for presenting a first interface to a user to receive location data, retrieving building characteristic information from a first one or more third-party systems based on the location data, presenting a second interface to the user pre-populated with the building characteristic information, and generating a homeowner's insurance quote based on the building characteristic information and the additional data when executed by the computer processor.

The validation engine includes program instructions stored in the memory, for determining key data elements associated with the quote and validating values of the key data elements, when executed by the computer processor.

A communication device, coupled to the computer processor, presents the first interface and the second interface, and a policy issuance engine to receive an acceptance of the homeowner's insurance quote and to issue a corresponding homeowner's insurance policy.

Identification of the key data elements and validation of the values of the key data elements may occur in any suitable manner and at any suitable stage according to some embodiments. For example, the key data elements may be determined and their values validated in response to a request of the user to purchase a policy associated with the quote. In other embodiments, the key data elements may be determined and their values validated in response to a request of the user for the quote.

Validation of the values of the key data elements may include determination of an exposure associated with the quote, performance of a first type of validation of the values of the key data elements if the exposure is less than a threshold value, and performance of a second type of validation of the values of the key data elements if the exposure is greater than the threshold value.

In some embodiments, validation of the values of the key data elements comprises performing a first type of validation of the values of the key data elements, performing a second type of validation of the values of the key data elements, and determining if the result of the first type of validation is consistent with the result of the second type of validation.

In some embodiments, hazard information is also retrieved from a third one or more third-party systems based on the location data, the second interface is presented to the user pre-populated with the hazard information, and the homeowner's insurance quote is generated based on the building characteristic information and the hazard information. The first one or more third-party systems may be identical to the third one or more third-party systems.

Further aspects may include determination of the key data elements based on factors associated with the quote, wherein the key data elements determined for a first quote are different from the key data elements determined for a second quote.

With these and other advantages and features that will become apparent, embodiments may be more clearly understood by reference to the following detailed description, the appended claims, and the drawings attached hereto.

### BRIEF DESCRIPTION OF THE DRAWINGS

FIG. 1 illustrates a system architecture within which some embodiments may be implemented.

FIG. 2 is a partial functional block diagram of a computer system provided in accordance with some embodiments.

FIG. 3 is a partial functional block diagram of a computer system provided in accordance with some embodiments.

FIG. 4 is a flow diagram of a process according to some embodiments.

FIG. 5 is a outward view of an interface to receive location information according to some embodiments.

FIG. 6 is a outward view of an interface to present pre-populated third-party information according to some embodiments.

FIG. 7 is a outward view of an interface to receive additional information according to some embodiments.

FIG. 8 illustrates a system architecture within which some embodiments may be implemented.

FIG. 9 is a outward view of an interface to present a quote according to some embodiments.

FIG. 10 is a tabular representation of data used to determine key data elements according to some embodiments

FIG. 11 is a outward view of an interface to validate data according to some embodiments.

FIG. 12 is a flow diagram of a process according to some embodiments.

FIG. 13 is a flow diagram of a process according to some embodiments.

FIG. 14 is a flow diagram of a process according to some embodiments.

### DETAILED DESCRIPTION

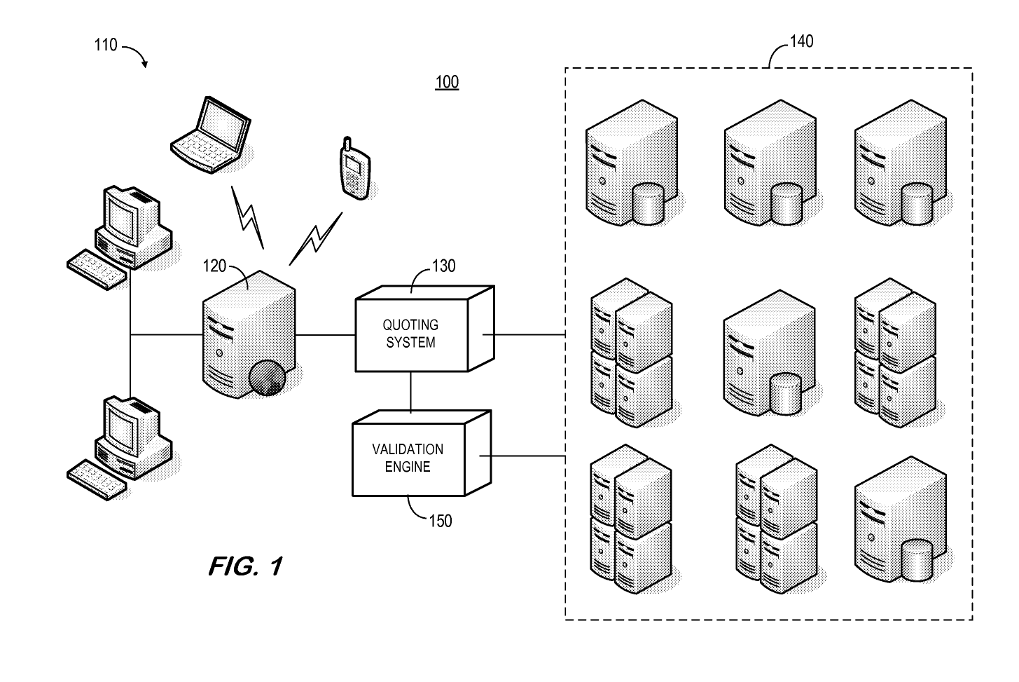

FIG. 1 illustrates system architecture 100 within which some embodiments may be implemented. Although some devices of architecture 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 1, requester devices 110 comprise any suitable devices for requesting and displaying user interfaces, including but not limited to desktop computers, cell phones, personal digital assistants, and laptops. As will be described below, the interfaces may be pre-populated with information received from a third-party. Devices 110 may be used to enter information into such interfaces and provide the information to another device. In some embodiments, devices 110 are operated by insurance agents, customer service professionals of an insurer, and/or an individuals shopping for insurance. Any number of requester devices 110 may be employed according to some embodiments.

Web server 120 may receive requests for interfaces from and may transmit such interfaces to requester devices 110. Such interfaces may comprise Web pages for receiving location information from requester devices 110 and providing the information to quoting system 130. As will be described in detail below, quoting system 130 may generate a homeowner's insurance quote based at least partially on location information received from one or more of requester devices 110. Quoting system 130 may comprise any combination of hardware and/or processor-executable instructions stored on a tangible medium. According to some embodiments, quoting system 130 is a component of Web server 120.

A quote generated by quoting system 130 is also based at least partially on information received from one or more of third-party data sources 140. Each of third-party data sources 140 may comprise any number and type of systems for storing data, including but not limited to relational databases, application servers, and spreadsheets. “Third-party”, as used herein, refers to a party external to a user of one of devices 110 from whom location information is received as mentioned above and the party operating quoting system 130 (e.g., an insurance company).

Third-party data sources 140 may be operated by more than one third party, and a single third party may operate more than one of data sources 140. Access to one or more of third-party data sources 140 may or may not be fee-based. Third-party data sources 140 may include public records, credit histories, loss histories, insurance coverage records, insurance claim records, tax information, building occupancy information and/or any other suitable data sources for use in conjunction with some embodiments.

Validation engine 150 may comprise any combination of hardware and/or processor-executable instructions stored on a tangible medium, and may also be a component of Web server 120. In some embodiments, validation engine 150 determines key data elements associated with a quote and validates values of the key data elements prior to purchase of a homeowner's insurance policy associated with the quote.

Validation engine 150 may perform any suitable type of validation. In some embodiments, validation engine 150 presents an interface to a user asking the user to confirm the values of the key data elements provided by one or more of third-party data sources 150. Some embodiments include validating the values of the key data elements against a first set of one or more of third-party data sources 150 if the quote and/or policy meet certain criteria (e.g., total exposure greater than a threshold amount) validating the values of the key data elements against a second set of one or more of third-party data sources 150 if the quote and/or policy do not meet the certain criteria. As will be described below, validation engine may also or alternatively operate to perform a first type of validation of the values of the key data elements, perform a second type of validation of the values of the key data elements, and determine if the result of the first type of validation is consistent with the result of the second type of validation.

It should be noted that embodiments are not limited to the devices illustrated in FIG. 1. Each device may include any number of disparate hardware and/or software elements, some of which may be located remotely from one another. Functions attributed to one device may be performed by one or more other devices in some embodiments. The devices of system 100 may communicate with one another (and with other non-illustrated elements) over any suitable communication media and protocols that are or become known.

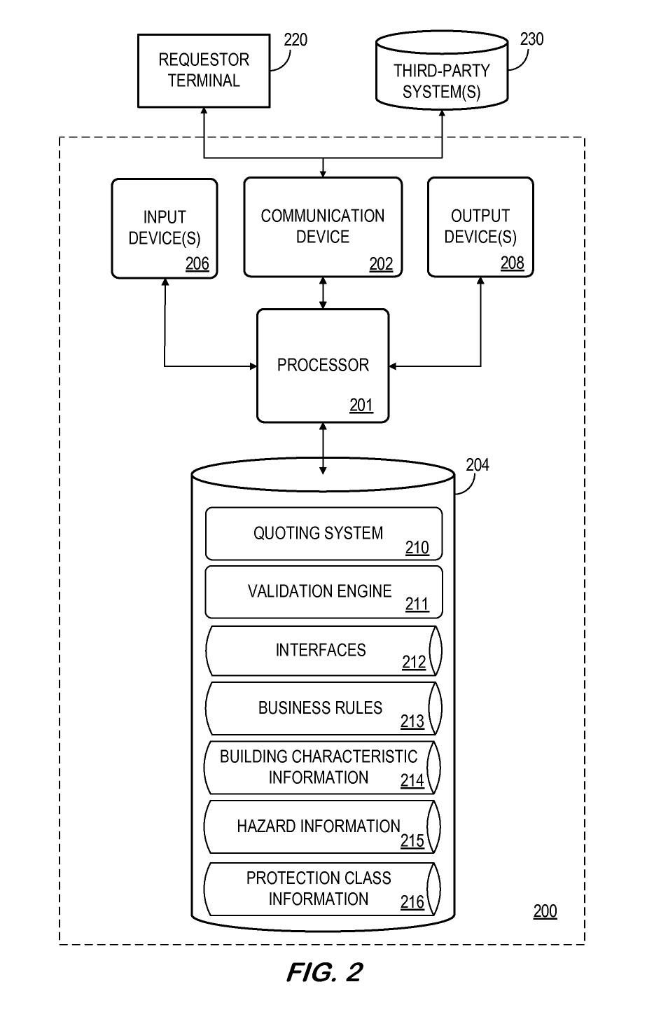

FIG. 2 is a block diagram of computer system 200 according to some embodiments. Computer system 200 may perform the functions attributed above to quoting system 130 and validation recommendation engine 140. Computer system 200 includes computer processor 201 operatively coupled to communication device 202, data storage device 204, one or more input devices 206 and one or more output devices 208. Communication device 202 may facilitate communication with external devices. Input device(s) 206 may comprise, for example, a keyboard, a keypad, a mouse or other pointing device, a microphone, knob or a switch, an infra-red (IR) port, a docking station, and/or a touch screen. Input device(s) 206 may be used, for example, to enter information into computer system 200. Output device(s) 208 may comprise, for example, a display (e.g., a display screen) a speaker, and/or a printer.

Data storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Data storage device 204 stores program instructions for execution by processor 200. Quoting system 210 may comprise a set of such instructions, and may be executed by processor 201 to cause system 200 to operate as described above with respect to quoting system 140 of FIG. 1. Similarly, validation engine 211 may comprise a set of program instructions executable by processor 201 to cause system 200 to operate as described above with respect to validation engine 150.

Data storage device 204 stores other data used and/or generated during operation according to some embodiments. This data includes interfaces 212 which may be provided to requestor terminal 220 in order to receive information therefrom. One or more of interfaces 212 may be pre-populated with information received from third-party systems 230 prior to being provided to requester terminal 220.

Business rules 213 may comprise software scripts, macros, routines, algorithms, etc. which govern the quoting and validation processes described herein. Rules 213 may therefore allow for differences in process flow based on differences in the business characteristics of a particular scenario. Rules 213 may also facilitate the modification of quoting and validation processes according to some embodiments.

Building characteristic information 214, hazard information 215 and protection class information 216 may be retrieved from third-party systems 230 and stored in device 204. Such storage may reduce a need to retrieve identical data from third-party systems 230 more than once. Building characteristic information 214 may include any information which may be used to generate a homeowner's insurance quote. For example, the building characteristic information may comprise one or more of a year built, a size, construction materials, the quality of these materials and finishes within the building, local labor costs, and/or any other information that may be useful in determining a replacement cost value, but embodiments are not limited thereto.

Hazard information 215 may include any information relating to hazards inherent to the building, including but not limited to proximity to shoreline, brushfire risks, flooding risks, etc. Protection class information 216 may reflect a level of protection available to the building (e.g., distance to fire hydrant/fire department, etc.). Embodiments are not limited to the information of shown in FIG. 2 or to storage of such information separate from third-party systems 230.

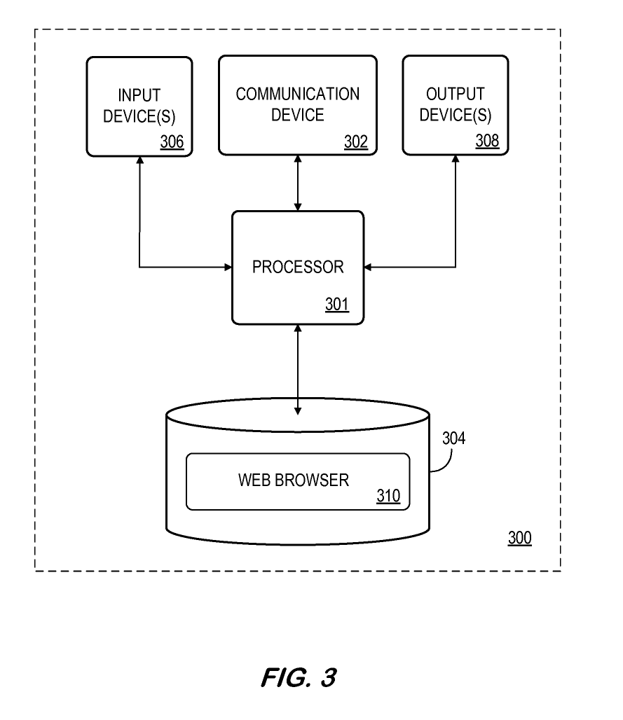

FIG. 3 is a block diagram of computer system 300 according to some embodiments. Computer system 300 may perform the functions attributed above to a requester terminal 110. Computer system 300 includes computer processor 301, which is operatively coupled to communication device 302, data storage device 304, one or more input devices 306 and one or more output devices 308. Communication device 302 may facilitate communication with external devices. Input device(s) 306 and output device(s) 308 may comprise any devices described above with respect to input device(s) 206 and output device(s) 208, but are not limited thereto.

Data storage device 304 may comprise any appropriate information storage device, including combinations of magnetic storage devices (e.g., magnetic tape and hard disk drives), optical storage devices, and/or semiconductor memory devices such as RAM devices and ROM devices.

Data storage device 304 stores program instructions for execution by processor 300, such as Web browser 310. Web browser 310 may be executed by processor 301 to cause system 300 to submit entity data via a Web page to Web server 120 and receive a Web page from Web server 120 including interfaces for receiving data and/or for displaying pre-populated data relating to a homeowner's insurance quote. Data storage device 304 may also store other applications, device drivers and data files usable to provide additional functionality to computer system 300.

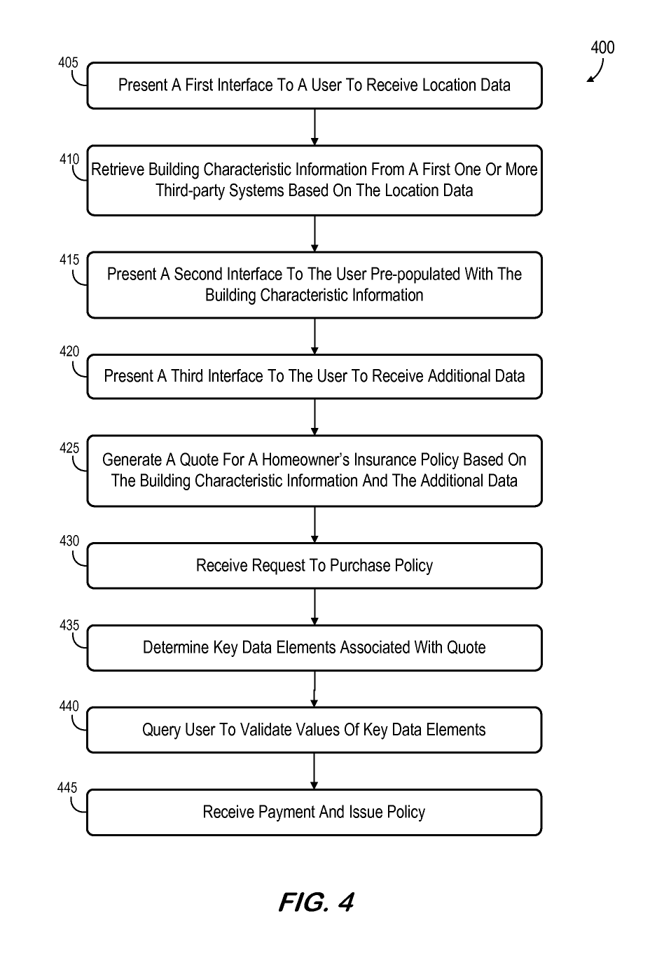

FIG. 4 is a flow diagram of process 400 according to some embodiments. Various elements of system architecture 100 and/or computer system 200 may execute process 400 according to some embodiments. Process 400 may be embodied within program instructions of quoting system 210 and validation engine 211 of computer system 200, but embodiments are not limited thereto.

Process 400 and all other processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

Initially, at 405, a first interface is presented to a user to receive location data. For example, a user operates one of requestor devices 110 or computer system 300 to execute a Web browser. The user manipulates an interface of the Web browser to request, receive and display a Web page of Web server 120 (or of computer system 200) which includes the first interface.

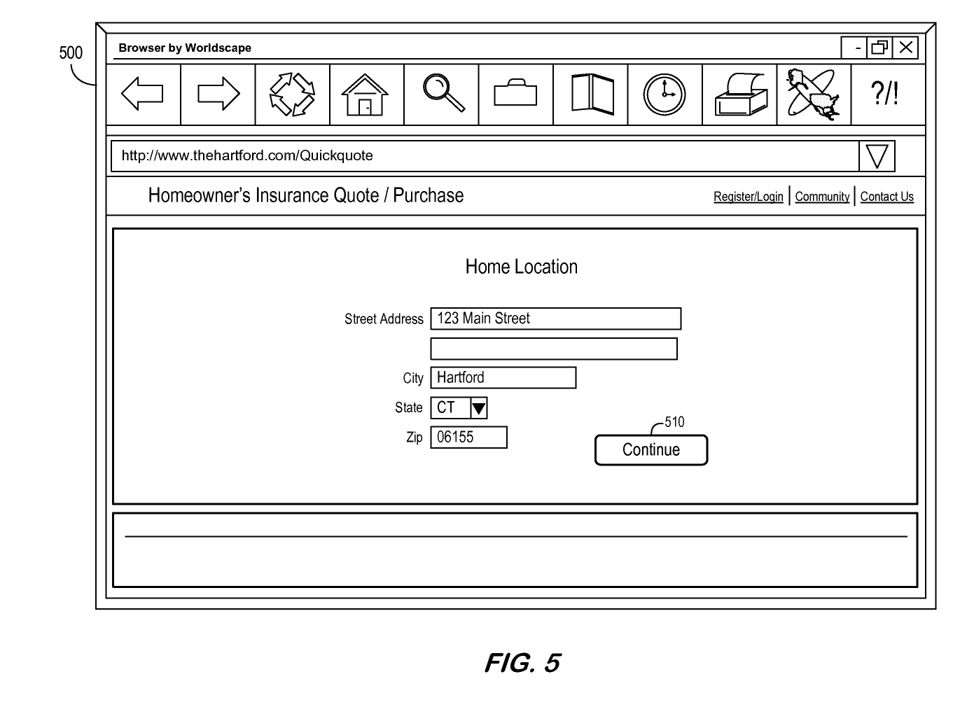

FIG. 5 is an outward view of interface 500 from which location data may be presented according to some embodiments of 405. Interface 500 includes labeled input boxes, one of which includes a drop-down menu (i.e., the State input box). However, any metaphor for acquiring data from a user may be employed. Moreover, several different interfaces may be presented to a user in order to receive location data at 405.

Continuing with the example, the user operates an input device 306 to complete the input boxes of interface 500 with location data and selects Continue icon 510. The selection of Continue icon 510 transmits the location data to quoting system 130 (or system 200). Accordingly, at 410, building characteristic information is retrieved from one or more third party systems (e.g., third-party systems 150) based on the location data.

Building characteristic information may be retrieved from public records (e.g., tax assessor records) and/or from private services. Some of such third-party systems may charge a fee for access to their building characteristic information. Any currently- or hereafter-known third-party systems for providing building characteristic information may be employed at 410.

According to some embodiments, other information is also retrieved from third-party systems based on the location data at 410. For example, the location data may be used to retrieve hazard information and/or protection class information as described above. This additional information may be retrieved from any one or more third-party systems, including but not limited to any systems from which the building characteristic information is retrieved.

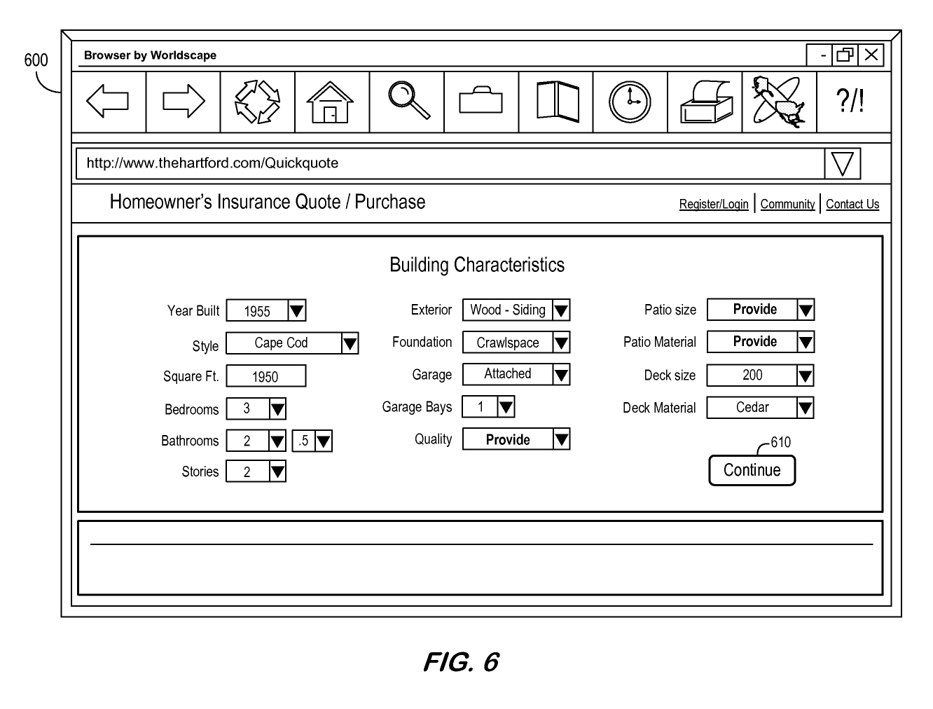

A second interface is presented to the user at 415. The second interface is pre-populated with the retrieved building characteristic information. FIG. 6 provides an example of second interface 600 according to some embodiments. Second interface provides several input boxes, some of which are pre-populated with building characteristic information retrieved at 410 and others which are populated with “Provide”. Accordingly, the user is expected to provide the data specified in the latter input boxes. In some embodiments, the user is also able to change some or all of the pre-populated building characteristic information to more accurately reflect the property in question.

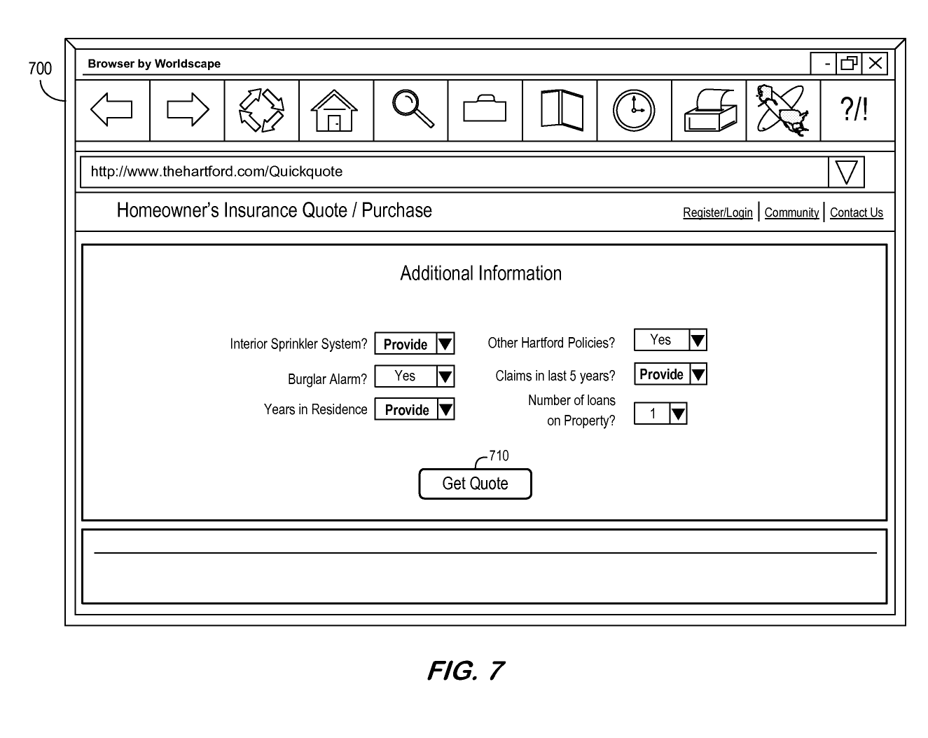

In response to selection of Continue icon 610, a third interface such as interface 700 of FIG. 7 is presented to the user. The third interface is intended to receive additional data from the user. The additional data may comprise any data that may assist in determining the user's eligibility for insurance and/or a price of the insurance. In this regard, the fields shown in interface 700 are only examples. Some fields of interface 700 are pre-populated, but embodiments are not limited thereto. The data in the pre-populated fields may have been retrieved from third-party systems and/or from internal systems. In some embodiments, the input boxes of interface 600 which are not pre-populated may be considered the “third interface” of 420.

The user selects Get Quote icon 710 to transmit the additional information to quoting system 130 (or computer system 200). Next, at 425, a quote for a homeowner's insurance policy is generated based on the building characteristic information and the additional data. Any other information, including but not limited to hazard information and protection class information, may be used at 425 to generate the quote. In this regard, embodiments are not limited to any particular process for generating the quote at 425. Any suitable system, including publicly-known and/or proprietary algorithms, may be used to generate the quote.

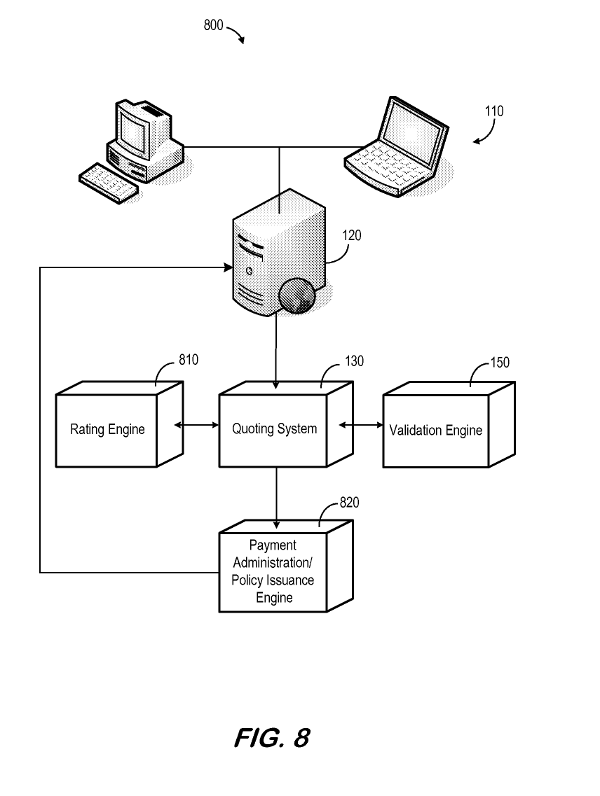

FIG. 8 is a diagram illustrating system architecture 800 to generate a quote according to some embodiments. Each element of architecture 800 may be implemented using one or more hardware devices, and two or more elements may be implemented using a single hardware device. Architecture 800 includes requestor devices 110, Web server 120, quoting system 130, and validation engine 150, each of which may perform functions such as those attributed thereto in the present description. Third-party systems 140 have been omitted for clarity.

According to some embodiments of 425, quoting system 130 transmits the received information to rating engine 810 and receives rating information in return according to known protocols. Based on the results, rating engine 810 (and/or quoting system 130) formulates a quote (e.g., according to known processes) and presents the quote to the user via Web server 120 or another communication mode (e.g., another Web server, electronic mail, post, etc.).

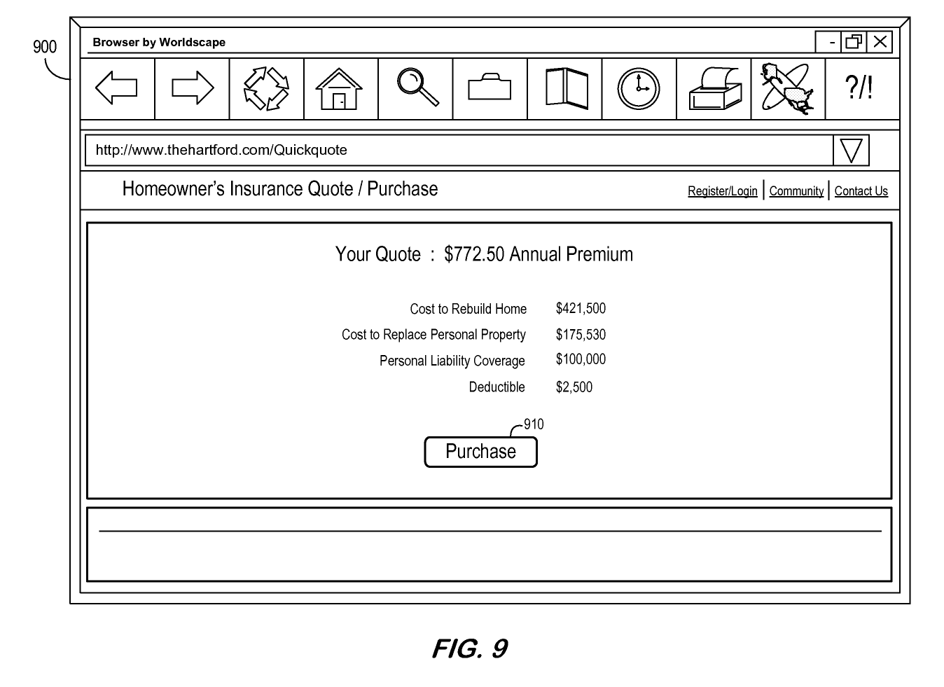

FIG. 9 illustrates interface 900 to present the generated quote to the user according to some embodiments. The quote includes an annual premium and coverage details. Embodiments are not limited to the presentation of interface 900 or to any of the coverage types or amounts shown therein. Purchase icon 910 may be selected to transmit a request to purchase a policy associated with the presented quote.

The request is received at 430. In response, key data elements associated with the quote are determined at 435 by, for example, validation engine 150. The key data elements may comprise any type of data that carries a greater-than-average weight in determining the premium and/or coverage amounts. As such, it may be deemed worthwhile to perform additional validation of this data before issuing a policy. The key data elements may alternatively or also comprise types of data that are time-consuming or costly to validate, such that the validation thereof is deemed worthwhile only once a user has requested to purchase a policy.

The determined key data elements may differ depending on any factors associated with the current quote. These factors may be reflected in business rules 213 of data storage device 204. For example, the key data elements may comprise quality grade information (e.g., custom, semi-custom, etc.) if the replacement cost value is greater than a predetermined threshold (e.g., $400,000, the 75^{th} percentile of home values in the current location, etc.). In another example, the key data elements may comprise hazard information if a credit rating of the homeowner is high. In some embodiments, the determination at 435 may indicate that no key data elements associated with the current quote needs to be validated.

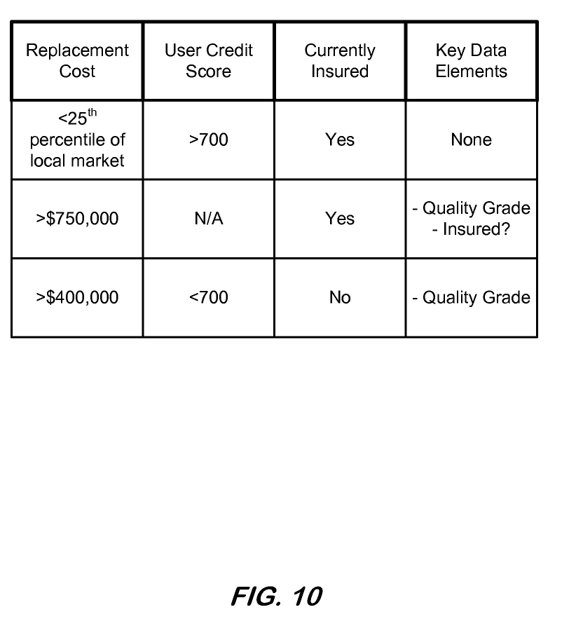

FIG. 10 is a tabular representation of data used to determine key data elements according to some embodiments. As shown, the determined key data elements may differ depending on various factors associated with the current quote. Embodiments are not limited to the key data elements or to the factors illustrated in FIG. 10. Also, as shown, more than one type of key data elements may be determined at 435 for a given quote.

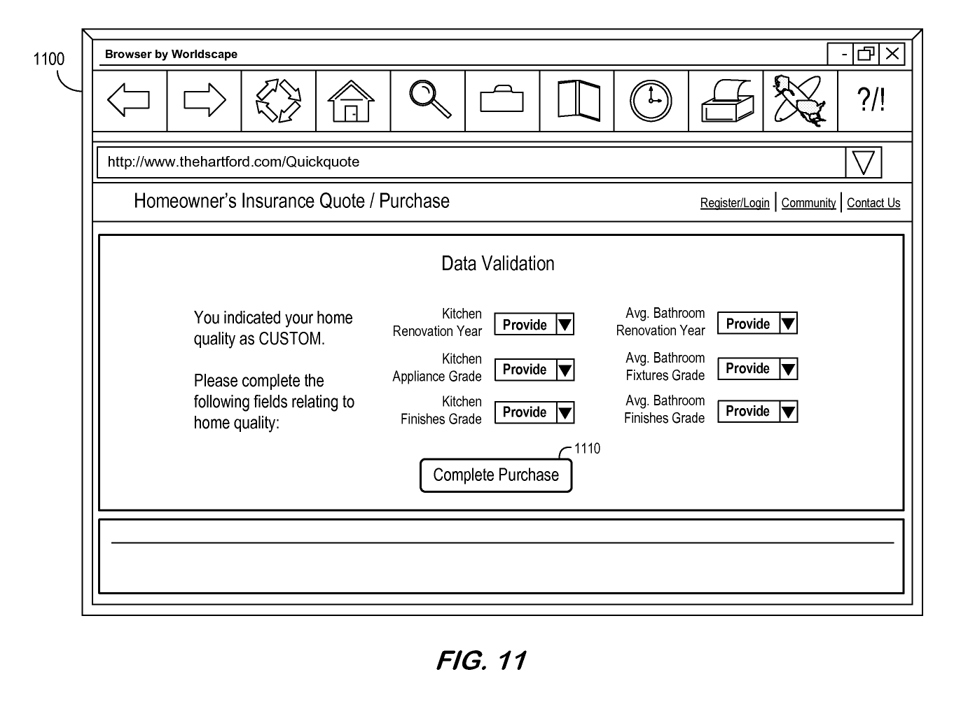

In the present example, it is determined that the key data elements comprise the quality grade of the property in question. After determining the key data elements, the user is queried to validate values of the key data elements. FIG. 11 illustrates interface 1100 which may be presented to query a user at 440. Each of the input boxes of interface 1100 may be completed by the user in order to validate the values of the key data elements. The user then selects Complete Purchase icon 1110.

In some embodiments, payment is received and a corresponding homeowner's insurance policy is issued at 445. For example, payment administration/policy issuance engine 820 of architecture 800 may present terms of the homeowner's insurance policy to the user, receive an acceptance of the terms (e.g., a credit card number) from the user, and issue the homeowner's insurance policy (e.g. policy documents). Accordingly, engine 820 may also debit a bank account of the user. These steps are intended to establish a legally-binding insurance contract.

Any other type of validation that is or becomes known may be utilized at 440. For example, the user may be simply asked to reconfirm already-entered or pre-populated information, and/or the user may be asked questions from which validation engine 150 is able to deduce the values of the key data elements.

According to some embodiments, the quote may change depending on the result of the validation (e.g., if the validated values do not agree with the values based upon which the quote was generated). Therefore, the terms presented at 445 may specify a price that is different from the quote presented at 425.

Validation in some embodiments comprises checking already-entered or pre-populated information against third-party systems. As mentioned above, these checks may be time-consuming or costly, and therefore only performed if the user has requested to purchase a policy.

Validation according to some embodiments may allow the offering of a coverage guarantee to the user. For example, after key data values are successfully validated, the policy terms may include a guarantee of coverage for the total actual replacement cost, rather than coverage only up to a determined replacement cost. This guarantee may or may not be limited to a particular amount. Some embodiments may offer the user to purchase such a guarantee for an additional cost at 445, with the additional cost being determined based on any suitable factors, including but not limited to the validation results.

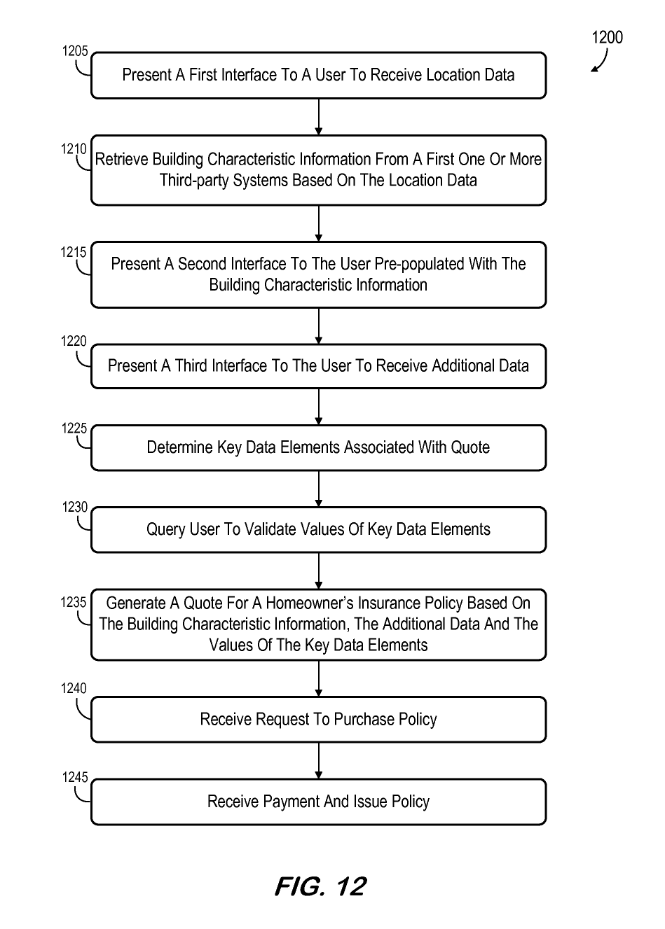

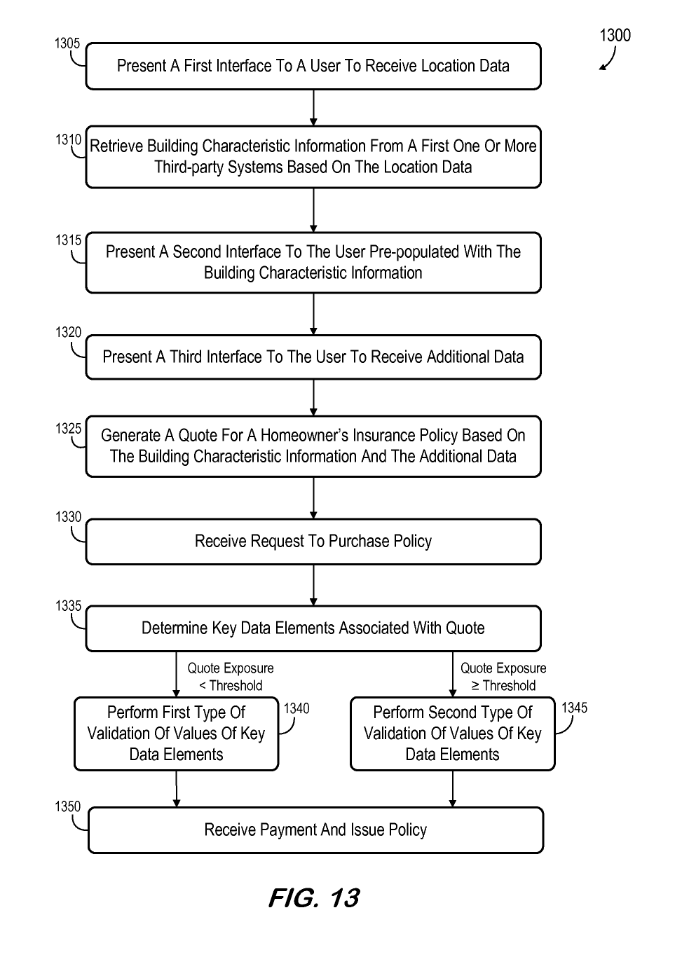

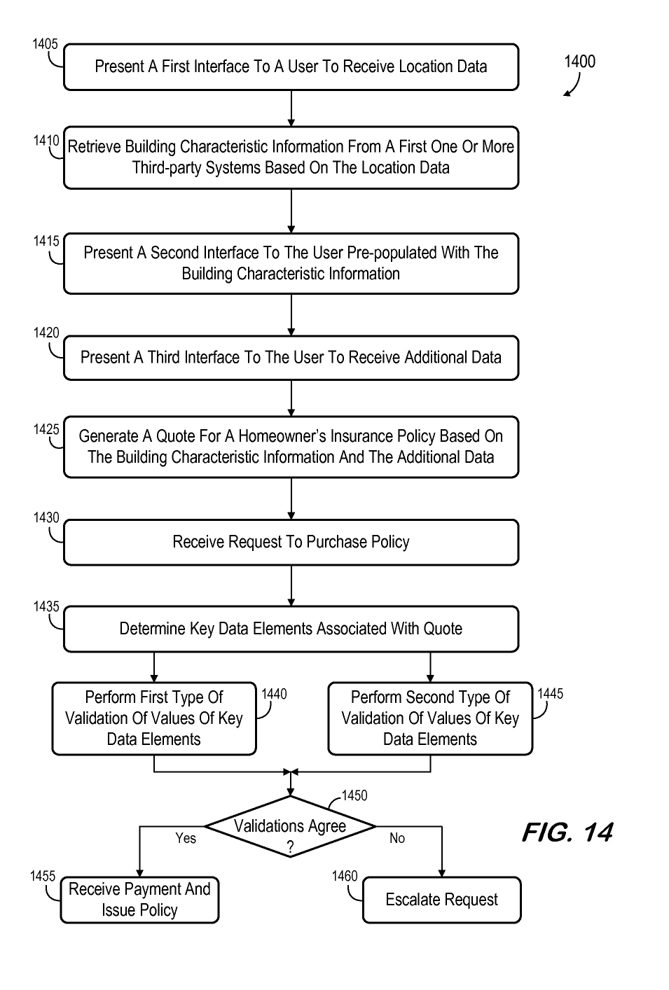

FIGS. 12 through 14 comprise flow diagrams of other processes according to some embodiments. These processes may be executed by various elements of system architectures 100, 800 and/or computer system 200, but embodiments are not limited thereto.

Process 1200 is similar to process 400 of FIG. 4. In contrast to process 400, key data elements determined and the values thereof are validated prior to generating the quote. More particularly, 1205 through 1220 may proceed as described above with respect to respective ones of 405 through 420. Next, 1225 and 1230 proceed as described above with respect to 435 and 440, respectively. Process 1200 may thereby provide a more suitable quote than process 400 in some embodiments, but may provide less efficiency in some embodiments due to the determination and validation prior to the generation of each quote. As described with respect to 440, the validation at 1230 may comprise any suitable type of validation, not limited to a direct user query as illustrated by interface 1100.

Some embodiments comprise a combination of process 400 and process 1200, in that a first validation is performed in response to the request for the quote and a second validation is performed in response to the request for purchase. The first validation may differ from the second validation, and the key data elements determined for each validation may also (or alternatively) differ. Process 1300 embodies a different type of validation procedure than previously described. 1305 through 1335 may proceed as described above with respect to 405 through 435, respectively. However, after the key data elements are determined at 1335, either a first type of validation is performed at 1340 or a second type of validation is performed at 1345. The first type of validation is performed at 1340 if the exposure associated with the quote is less than a predetermined threshold, and the second type of validation is performed at 1345 if the exposure associated with the quote is greater than or equal to the predetermined threshold.

Either the first type of validation or the second type of validation may comprise any type of validation mentioned herein or otherwise known. For example, the first type of validation may comprise querying the user as described with respect to 440, while the second type of validation may comprise querying a third-party system to validate the values of the key data elements. Regardless of the type of validation performed, flow continues to 1350 to receive payment and issue a policy as described above.

1405 through 1435 of process 1400 may also proceed as described above with respect to respective ones of 405 through 435. A first type of validation of values of the key data elements is then performed at 1440 and a second type of validation of the values of the key data elements is performed at 1445. Again, the first and second types of validations may proceed in any known manner. At 1450, it is determined whether the validations agree with one another. The determination at 1450 may comprise a determination of whether the values of the key data elements determined by the first validation are identical (or suitably similar) to the values of the key data elements determined by the second validation.

Flow proceeds to 1455 to receive payment and issue a policy if the determination at 1450 is positive. If the determination at 1450 is negative, flow proceeds to 1460 to escalate the request to purchase the policy. Escalation at 1460 may comprise contacting an underwriter to resolve the discrepancy in the key data elements. Escalation at 1460 may therefore comprise a partially-manual validation of the key data elements, but embodiments are not limited thereto.

Validation according to some embodiments is not limited to the description herein. For example, validation may occur any time during the quoting/issuance process, and may occur more than once during the process. Some of the values of the determined key data elements may be validated by one type of validation and other values of the key data elements may be validated using another type of validation. Validation may consist of multiple validation stages. For example, a lower-cost validation may be followed by a higher-cost validation only if the lower-cost validation fails to suitably validate the values of the determined key data elements.

The embodiments described herein are solely for the purpose of illustration. Those in the art will recognize that other embodiments may be practiced with modifications and alterations limited only by the claims.

What is claimed is:

1. A computer system to provide an insurance quote, the system comprising:
a data storage device for receiving, storing, and providing access to building characteristic information;
a computer processor for executing program instructions and for retrieving the building characteristic information from the data storage device;
a memory, coupled to the computer processor, for storing program instructions for execution by the computer processor;
a quoting system comprising program instructions stored in the memory, for presenting a first interface to a user to receive location data, retrieving building characteristic information from a first one or more third-party systems based on the location data, presenting a second interface to the user pre-populated with the building characteristic information, and generating a quote for a homeowner's insurance policy based on the building characteristic information, when executed by the computer processor;
a validation engine comprising program instructions stored in the memory, for determining key data elements associated with the quote and validating values of the key data elements, when executed by the computer processor; and
a communication device, coupled to the computer processor, for presenting the first interface and the second interface.

2. A computer system according to claim 1, wherein the quoting system is further to:
retrieve hazard information from a second one or more third-party systems based on the location data;
present the second interface to the user pre-populated with the hazard information; and
generate the homeowner's insurance quote based on the building characteristic information and the hazard information.

3. A computer system according to claim 1, further comprising a policy issuance engine to present the terms of the homeowner's insurance policy and to offer a coverage guarantee for an actual replacement cost.

4. A computer system according to claim 3, wherein the offer includes a premium amount additional to the quote and associated with the coverage guarantee.

5. A computer system according to claim 1, wherein the validation engine is to determine key data elements and validate the values of the key data elements in response to a request of the user to purchase a policy associated with the quote.

6. A computer system according to claim 1, wherein the validation engine is to determine key data elements and validate the values of the key data elements in response to a request of the user for the quote.

7. A computer system according to claim 1, wherein the validation engine is to validate the values of the key data elements by:
determining an exposure associated with the quote;
perform a first type of validation of the values of the key data elements if the exposure is less than a threshold value; and
perform a second type of validation of the values of the key data elements if the exposure is greater than or equal to the threshold value.

8. A computer system according to claim 1, wherein the validation engine is to validate the key data elements by:
performing a first type of validation of the values of the key data elements;
performing a second type of validation of the values of the key data elements; and
determining if the result of the first type of validation is consistent with the result of the second type of validation.

9. A computer system according to claim 1, wherein the validation engine is to determine the key data elements based on factors associated with the quote, and wherein the key data elements determined for a first quote are different from the key data elements determined for a second quote.

10. A method of operating a computer method to provide an insurance quote, the method comprising:
presenting a first interface to a user to receive location data;
retrieving building characteristic information from a first one or more third-party systems based on the location data;
presenting a second interface pre-populated with the building characteristic information;
generating a quote for a homeowner's insurance policy based on the building characteristic information;
receiving a request to purchase the homeowner's insurance policy;
determining key data elements associated with the quote;
validating values of the key data elements;
presenting terms of the homeowner's insurance policy;
receiving an acceptance of the terms of the homeowner's insurance policy; and
issuing the homeowner's insurance policy.

11. A method according to claim 10, wherein presenting the terms of the homeowner's insurance policy comprises offering a coverage guarantee for an actual replacement cost.

12. A method according to claim 11, wherein presenting the terms of the homeowner's insurance policy comprises specifying a premium amount additional to the quote and associated with the coverage guarantee.

13. A method according to claim 10, further comprising:
retrieving hazard information from a second one or more third-party systems based on the location data,
wherein the second interface is pre-populated with the hazard information, and
wherein generating the homeowner's insurance quote comprises generating the homeowner's insurance quote based on the building characteristic information and the hazard information.

14. A method according to claim 10, wherein the key data elements are determined and the values of the key data elements are validated in response to the received request purchase the homeowner's policy.

15. A method according to claim 10, wherein the key data elements are determined and the values of the key data elements are validated prior to generation of the quote.

16. A method according to claim 10, wherein determining the key data elements and validating the values of the key data elements comprises:
determining an exposure associated with the quote;
performing a first type of validation of the values of the key data elements if the exposure is less than a threshold value; and
performing a second type of validation of the values of the key data elements if the exposure is greater than or equal to the threshold value.

17. A method according to claim 10, wherein validating the values of the key data elements comprises:
performing a first type of validation of the values of the key data elements;
performing a second type of validation of the values of the key data elements; and
determining if the result of the first type of validation is consistent with the result of the second type of validation.

18. A method according to claim 10, wherein the key data elements are determined based on factors associated with the quote, and
wherein the key data elements determined for a first quote are different from the key data elements determined for a second quote.

19. A system to provide an insurance quote, the system comprising:
a first one or more third-party systems storing building characteristic information;
a second one or more third-party systems storing data;
a quoting system to present a first interface to receive location data from a user, to retrieve building characteristic information from the first one or more third-party systems based on the location data, to present a second interface pre-populated with the building characteristic information to the user, to generate a homeowner's insurance quote based on the building characteristic information, and to receive a request to purchase the homeowner's insurance policy;
a validation engine to determine key data elements associated with the quote and validate values of the key data elements;
; and
a policy issuance engine to present terms of the homeowner's insurance policy, to receive an acceptance of the terms, and to issue the homeowner's insurance policy.

20. A system according to claim 19, wherein the terms of the homeowner's insurance policy include a coverage guarantee for an actual replacement cost.

21. A system according to claim 20, wherein the terms of the homeowner's insurance policy include a premium amount in addition to the quote and associated with the coverage guarantee.

22. A system according to claim 19, further comprising:
a second one or more third-party systems storing hazard information,
wherein the second interface is pre-populated with the hazard information, and
wherein generating the homeowner's insurance quote comprises generating the homeowner's insurance quote based on the building characteristic information and the hazard information.

23. A system according to claim 19, wherein the validation engine is to determine key data elements and validate the values of the key data elements in response to a request of the user to purchase a policy associated with the quote.

24. A system according to claim 19, wherein the validation engine is to determine key data elements and validate the values of the key data elements in response to a request of the user for the quote.

25. A system according to claim 19, wherein the validation engine is to validate the values of the key data elements by:
determining an exposure associated with the quote;
performing a first type of validation of the values of the key data elements if the exposure is less than a threshold value; and
performing a second type of validation of the values of the key data elements if the exposure is greater than or equal to the threshold value.

26. A system according to claim 19, wherein the validation engine is to validate the values of the key data elements by:
performing a first type of validation of the values of the key data elements;
performing a second type of validation of the values of the key data elements; and
determining if the result of the first type of validation is consistent with the result of the second type of validation.

27. A system according to claim 19, wherein the validation engine is to determine the key data elements based on factors associated with the quote, and
wherein the key data elements determined for a first quote are different from the key data elements determined for a second quote.
